(19) United States
(12) Patent Application Publication
(10) Pub. No.: US 2001/0012369 A1
(43) Pub. Date: Aug. 9, 2001

(54) INTEGRATED PANEL LOUDSPEAKER SYSTEM ADAPTED TO BE MOUNTED IN A VEHICLE

(76) Inventor: STANLEY L. MARQUISS, PLYMOUTH, CA (US)

Correspondence Address: DUANE H MATHIOWETZ ESQ., TOWNSEND AND TOWNSEND AND CREW LLP, TWO EMBARCADERO CENTER, 8TH FLOOR, SAN FRANCISCO, CA, 941113834

(21) Appl. No.: 09/185,168

(22) Filed: Nov. 3, 1998

(51) Int. Cl. H04B 1/00

(52) U.S. Cl. 381/86

(57) ABSTRACT

An integrated panel loudspeaker system adapted to be mounted adjacent a roof of a vehicle is provided wherein time and phase coherent non-dispersive longitudinal waves are produced in a diaphragm of the system by a plurality of electromagnetic drive assemblies of the system so that the diaphragm radiates time coherent transverse waves within the vehicle with substantially the same wave forms as that of input signals to the drive assemblies. The system includes, in one embodiment, a panel formed of batting compressed and molded in a predetermined shape and having an elastic memory of the predetermined shape. The panel has a plurality of apertures formed therein in which the plurality of spaced electromagnetic drive assemblies are aligned. The diaphragm is a contour diaphragm for the panel wherein the diaphragm is adhesively secured to the panel with a resilient adhesive so that the diaphragm is critically damped. Preferably the diaphragm is formed from a thin sheet of non-ferrous metal such as aluminum.

### TECHNICAL FIELD

This invention relates to integrated panel loudspeaker systems and, in particular, to integrated panel loudspeaker systems adapted to be mounted in a vehicle.

### BACKGROUND ART

The Marquiss U.S. Pat. Nos. 4,385,210, 4,792,978 and 4,856,071 disclose a variety of planar loudspeaker systems including substantially rigid planar diaphragms driven by cooperating coil and magnet units.

The Verity Group PLC has applied for a number of patents covering various aspects of flat panel loudspeaker technology. The technology operates on the principle of optimally distributive modes of vibration. A panel constructed in accordance with this technology has a very stiff structure and, when energized, develops complex vibration modes over its entire surface. In the panel the speed of wave propagation is not constant and the waves do not obey the classical wave equation. The panel is said to be dispersive in that the shape of the sound wave traveling in the panel is not preserved during propagation.

The U.S. Patent to Weinle, et al. U.S. Pat. No. 4,840,832 discloses an automobile headliner which is formed from a batt of polymeric fibers compressed and molded into a predetermined contoured shape.

The U.S. patent to Clark, et al, U.S. Pat. No. 5,754,664 discloses a vehicle audio system including overhead speakers connected to an audio source through a control circuit.

As is known in the art, a car interior is a very difficult acoustic environment in which to listen to music generated by loudspeakers. An abundance of hard glass window surfaces produce loud early reflections, which immediately mix with the direct loudspeaker sound, while the rest of the vehicle interior is normally quite sound absorbing.

The normal vehicle interior sound lacks sound image fidelity because the typical locations of loudspeakers and listeners in the small vehicle cabin are too close together. Concert quality sound does not normally come from a few feet away, and from door panel positions near the ankles or the elbows of the listener. Also, the quality of reflected sound from window surfaces makes specific sound image localization difficult. Whereas, to reproduce the original acoustical event, the sound should appear to come from in front of the listener, often in a vehicle it appears instead to emanate from a door panel speaker, or from another location.

### DISCLOSURE OF INVENTION

An object of the present invention is to provide an integrated panel loudspeaker system adapted to be mounted in a vehicle which can exactly replicate any audio signal.

Another object of the present invention is to provide an integrated panel loudspeaker system adapted to be mounted in a vehicle and which has a high order of active and passive integration wherein there is no distinction between the elements of the system that contribute mass and the elements that contribute stiffness, so that these integrated elements allow a linear, non-dispersive, zero order, high fidelity diaphragm to emit time coherent transverse and longitudinal waves.

Still another object of the present invention is to provide an integrated panel loudspeaker system adapted to be mounted in a vehicle wherein a non-ferrous thin metal diaphragm is provided so that all acoustical waves generated by mechanical movement of the diaphragm are instantly transmitted throughout the diaphragm.

In carrying out the above objects and other objects of the present invention, an integrated loudspeaker system adapted to be mounted in a vehicle is provided. The system includes a panel having a predetermined shape and at least one aperture formed therein. The system also includes an acoustical wave-producing contour diaphragm for the panel. The diaphragm is secured to the panel so that the diaphragm is critically damped. The system further includes at least one electromagnetic drive assembly having an electrical input and which is secured to the panel in alignment with the at least one aperture so that time and phase coherent non-dispersive longitudinal waves are produced in the diaphragm by the at least one drive assembly and so that the diaphragm radiates time coherent transverse waves within the vehicle with substantially the same wave form as that of the electrical input.

In one embodiment of the present invention, the panel is formed of batting compressed and molded in the predetermined shape and having an elastic memory of the predetermined shape.

Preferably, the system includes a plurality of spaced electromagnetic drive assemblies each having its own electrical input. The panel has a plurality of apertures formed therein. The drive assemblies are secured to the panel in alignment with their respective apertures so that time and phase coherent non-dispersive longitudinal waves are produced in the diaphragm by the drive assemblies and so that the diaphragm radiates time coherent transverse waves within the vehicle with substantially the same wave forms as that of the electrical inputs.

Preferably, each of the drive assemblies includes a coil and a magnet which moves relative to the coil in response to its electrical input. In one embodiment, the diaphragm if fixedly secured to each of the magnets to move therewith. In another embodiment, the diaphragm is fixedly secured to each of the coils to move therewith.

In another embodiment, at least one of the drive assemblies includes a pair of spaced apart magnets.

Preferably, each of the magnets is a high energy permanent magnet such as a rare-earth magnet.

The longitudinal waves travel in the diaphragm at a velocity at least as great as the velocity of sound in the air in the vehicle.

Preferably, the diaphragm is formed from a non-ferrous metal such as aluminum.

In one embodiment, the panel is adapted to be mounted adjacent a roof of the vehicle so as to underlie the roof and shield the roof from view.

In another embodiment, the panel is adapted to be mounted on a door of the vehicle.

An adhesive, such as a resilient adhesive, is typically provided for resiliently securing the diaphragm to the panel.

An integrated panel loudspeaker system constructed in accordance with the above provides numerous advantages. For example:

1. The planar headliner system is a time and frequency coherent device producing non-dispersive longitudinal waves, which can exactly replicate any audio signal, the central definition of polarity-inverted, active noise control. The planar headliner system is essentially a zero-order, non-inductive, non-capacitive, primarily resistive device.

2. The planar headliner system has a high order of active and passive integration. The active, Newtonian elements are controlled by the spring constant, restoring force, Hookean components, resulting in a total system in which there are no distinctions between the elements that contribute mass (i.e. the coil, and aluminum diaphragm), and the elements that contribute stiffness (i.e. the resilient headliner material). This integrated system of mass and stiffness components is the standard physics definition of a linear non-dispersive, zero order, high fidelity diaphragm emitting time coherent transverse and longitudinal waves.

3. Each permanent magnet, electromagnetic drive assembly runs at the intrinsic gauss level of its rare-earth magnet, not at a much lower level of a standard, inductive structure, iron or steel pole piece. There are no pole pieces in the planar headliner.

4. Because of the high transmission velocity through the aluminum diaphragm, all of the acoustical signals generated by the mechanical movement of the diaphragm-attached coils or magnets are instantly transmitted throughout the diaphragm, appearing essentially everywhere on the surface of the diaphragm at the same time. The speed of sound through air at standard temperature and pressure, (i.e., 21 degrees C) is 1129 feet per second. The speed of sound through aluminum is, on average, 16,896 feet per second. Many other materials could be substituted for aluminum in the planar headliner system. The large scale planar diaphragm is crossoverless. That is, there are no series or parallel inductors or capacitors in an electrical network dividing frequencies. Each driver assembly in the planar diaphragm is full range. Because of the transmission velocity through the diaphragm and the location of the driving coils or magnets, the diaphragm behaves mechanically as a large woofer at low frequencies, and progressively as a midrange and high frequency device, as the input goes up in frequency.

5. There are other embodiments of the drive assemblies, one being two spaced torus magnets in repulsion mode, within a larger coil. This elongated driver has greater low frequency capability.

6. The coil magnet relationship may be reversed, building either a moving coil or a moving magnet device.

7. The system may have a fully-integrated, multi-channel surround-sound system. The backside of the headliner may be incorporated with a mounted mirror as a center locating channel. The output from the back of the mirror would reflect to the listener again from the inside of the windshield. A further location could be on the sun visor, so that the sound would appear from in front of the listener, and thus create a perceived center of the sound image coming from in front, as would be normal in a concert hall setting. The speaker driver assembly could also be added to the underside center of the vehicle dash, therefore using the dash itself as the sound localizing center channel. One or two such drivers would be sufficient to produce a voice range, midrange localizing sound, essentially with any physical dash structure, including padded dash structures. It would not require a hole in the dashboard, and a cover for the hole; rather, it would simply require the attachment of the driver to the dash.

8. Active Noise Control can become a part of the planar headliner system.

It is also understood, of course, that while the form of the invention herein shown and described constitutes a preferred embodiment of the invention, it is not intended to illustrate all possible forms thereof. It should also be understood that the words used in the specification are words of description rather than limitation and various changes may be made without departing from the spirit and scope of the invention.

### BRIEF DESCRIPTION OF DRAWINGS

FIG. 1 is a first environmental view illustrating an integrated panel loudspeaker system of the present invention mounted adjacent a roof of a vehicle, indicated by phantom lines, so as to underlie the roof and shield the roof from view;

FIG. 2 is a second environmental view illustrating an integrated panel loudspeaker system of the present invention mounted in a door of the vehicle;

FIG. 3 is a top schematic view partially broken away, which illustrates conductive strip wiring electrically connected to a plurality of electromagnetic drive assemblies;

FIG. 4 is an exploded perspective view, partially broken away and in cross section, of the integrated panel loudspeaker system of the present invention;

FIG. 5 is a view, taken along lines 5-5 of FIG. 2, of a first embodiment of the integrated panel loudspeaker system wherein the electromagnetic drive assembly includes a coil fixedly secured to a diaphragm of the system;

FIG. 6 is a view, partially broken away and in cross section, of a second embodiment of the system including a magnet of the electromagnetic drive assembly fixedly secured to the diaphragm;

FIG. 7 is a view, partially broken away and in cross section, of a third embodiment of the system, wherein a magnet of the electromagnetic drive assembly is supported by a cup-shaped spacer disk; and

FIG. 8 is a view, partially broken away and in cross section, of a further embodiment of the system, including a pair of magnetically opposed magnets laterally supported by a post.

### BEST MODE FOR CARRYING OUT THE INVENTION

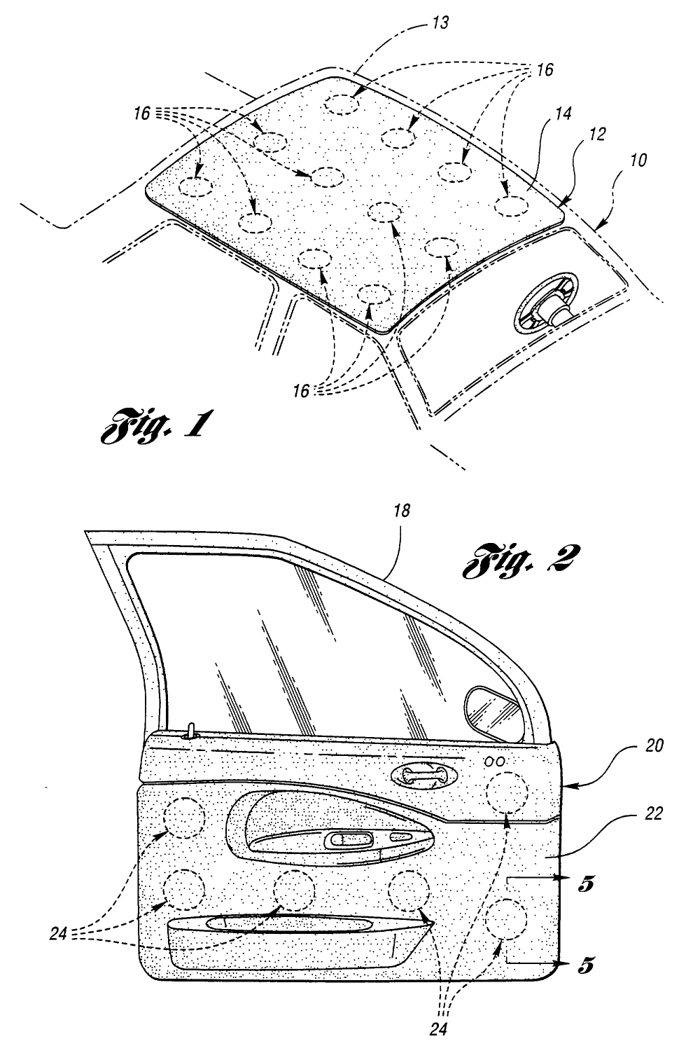

Referring now to FIG. 1, there is illustrated a vehicle, generally indicated in phantom by reference numeral 10, including an integrated panel loudspeaker system, generally indicated at 12, mounted adjacent a roof 13 of the vehicle 10 so as to underlie the roof 13 and shield the roof 13 from view as seen from the interior of the vehicle 10. The integrated panel loudspeaker system 12 topically includes an outer covering 14 which covers a plurality of spaced electromagnetic drive assemblies, generally indicated at 16, of the system 12.

Referring now to FIG. 2, there is illustrated a door 18 of the vehicle 10 which supports another embodiment of an integrated panel loudspeaker system, generally indicated at 20. An inner fabric covering 22 covers a plurality of spaced electromagnetic drive assemblies 24 of the system 20.

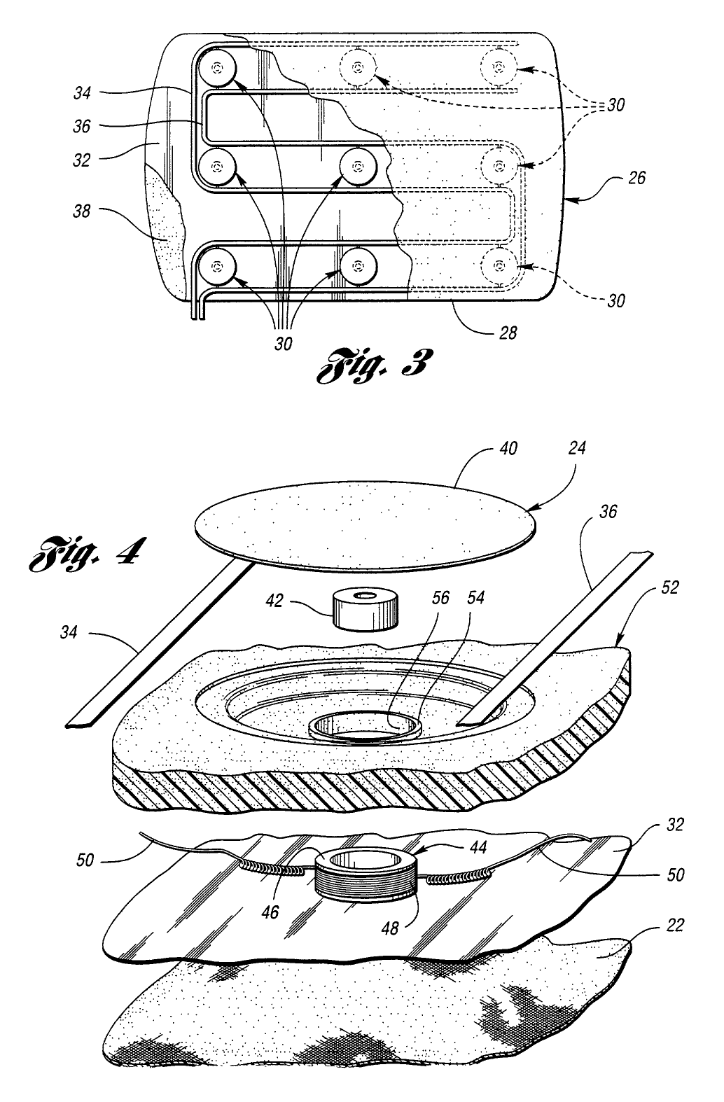

Referring now to FIG. 3, there is illustrated yet another integrated panel loudspeaker system, generally indicated at 26, which is adapted to be mounted in a vehicle such as the vehicle 10 and which may serve as an interior trim panel for the vehicle 10. The system 26 includes an outer fabric covering 28 which covers a plurality of spaced electromagnetic drive assemblies 30. The FIG. 3 shows the electromagnetic drive assemblies 30 without their corresponding panel to which the drive assemblies 30 are typically secured within apertures of the panel.

FIG. 3 also shows a sheet or diaphragm of non-ferrous metal such as an aluminum diaphragm 32, which is driven by the drive assemblies 30 so that time and phase coherent non-dispersive longitudinal waves are produced in the diaphragm 32 and so that the diaphragm 32 radiates time coherent transverse waves within the vehicle at substantially the same wave forms as that of electrical inputs to the drive assemblies 30.

The system 26 also preferably includes conductive strip wiring 34 and 36 wherein all of the drive assemblies 30 are connected in parallel to provide monophonic sound. It is to be understood, however, that the wiring can be easily changed to provide two or more channels of sound.

The system 26 also preferably includes an inner fabric covering 38 which typically may comprise conventional cover stock material.

Referring now to FIG. 4, there is provided an exploded perspective view, partially broken away and in cross section, illustrating the construction details of one of the electromagnetic drive assemblies 24 of FIG. 2. Each of the drive assemblies 24 typically includes plastic disk 40 to which there is fixedly secured, such as by a resilient adhesive, a rare-earth annular magnet 42 as also illustrated in FIG. 5. The annular magnet 42 is disposed within a bore of a coil, generally indicated at 44, also illustrated in FIG. 5. The coil 44 typically includes a nonferrous metal bobbin such as an aluminum bobbin 46 about which there is provided encapsulated wiring 48. The wiring 48 includes first and second wire terminals 50 which, in turn, are electrically connected to the conductive strips 34 and 36.

Still referring to FIG. 4, the integrated panel loudspeaker system also includes a panel, generally indicated at 52, which has a predetermined shape and a rim portion 54 through which an aperture 56 extends completely therethrough. As illustrated in FIG. 5 the electromagnetic drive assembly 30 is secured to the panel 52 in alignment with the aperture 56. The disk 40 is preferably adhesively secured to the panel 52. Preferably the panel 52 is formed of batting compressed and molded in the predetermined shape and has an elastic memory of the predetermined shape. U.S. Pat. No. 4,840,832 noted above discloses headliner material which has been found to be useful in the integrated panel loudspeaker system of the present invention.

The aluminum diaphragm 32 is also adhesively bonded at a lower surface of the panel 52 by a resilient adhesive for resiliently securing the aluminum diaphragm 32 to the panel 52. In this way the diaphragm 32 is critically damped.

Referring now to FIG. 5 take together with FIG. 4, the magnet 42 of the drive assembly 24 is fixedly secured to the plastic plate or disk 40 such as by resilient adhesive.

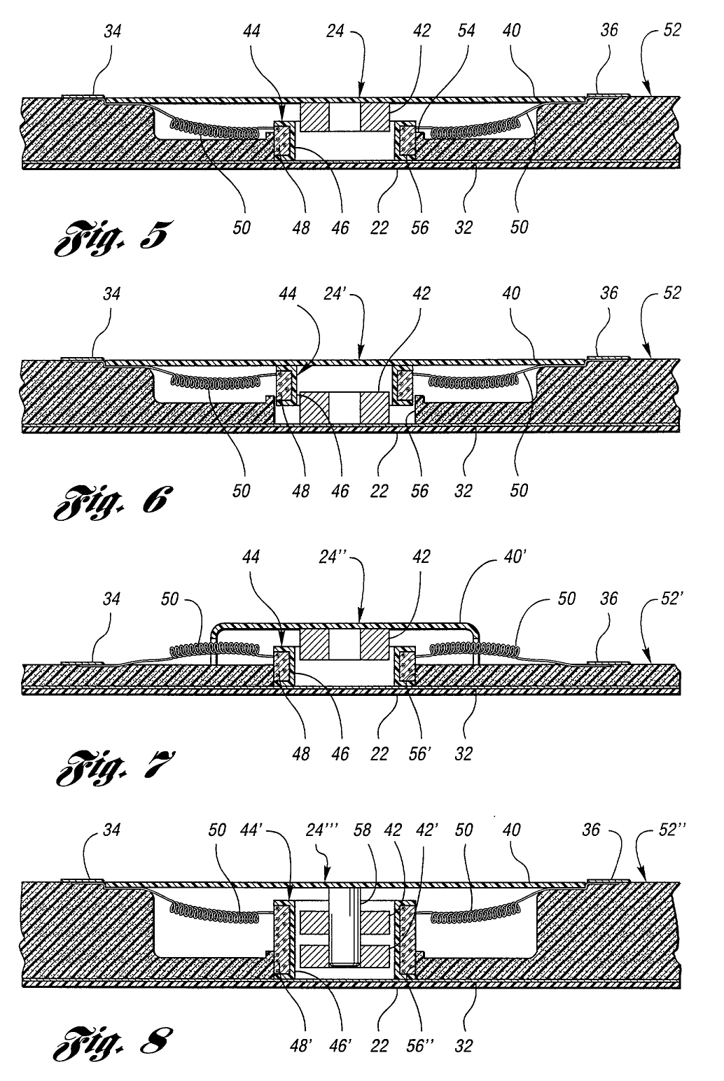

Referring now to FIG. 6, there is illustrated another embodiment of the integrated panel loudspeaker system of the present invention wherein an electromagnetic drive assembly 24′ includes the magnet 42 but its coil 44 is fixedly secured to the disk 40 and the magnet 42 is fixedly secured to the aluminum diaphragm 32 such as by solder.

In FIG. 6 together with drawing FIGS. 7 and 8, components which are the same as the components of the embodiment of FIG. 5 have the same reference number and those which are similar have the same reference number but are given a prime (′), double prime (″) or triple prime (′″) designation, respectively.

Referring now to FIG. 7, there is illustrated yet a third embodiment of a integrated panel loudspeaker system constructed in accordance with the present invention wherein a third electromagnetic drive assembly, generally indicated at 24″, is provided. The drive assembly 24″, instead of having a plastic disk 40, has a plastic, cup-shaped, spacer disk 40′ to reduce the thickness of a panel 52′, thereby reducing the cost of the system. The panel 52′ may be formed from TRU, a polyurethane foam which is sliced and bonded to two sheets of fiberglass laminate, one on each side. Alternatively, the panel 52′ may be formed from a very rigid sheet of cardboard material with fabric bonded to it (i.e. called Eften). Slots are formed in side walls of the spacer disk 40′ to allow the wire terminals 50 to extend therethrough and make electrical connection with the conductive strip wiring 34 and 36.

Referring now to FIG. 8, there is illustrated yet a fourth embodiment of the integrated panel loudspeaker system of the present invention wherein an electromagnetic drive assembly 24′″ is provided within a panel, generally indicated at 52″, having increased thickness to accommodate a pair of rare-earth magnets 42 and 42′ supported by a post 58 fixedly secured at the lower surface of the plastic disk 40. The magnets 42 and 42′ are disposed within a bore of an elongated coil, generally indicated at 44′, having an elongated bobbin 46′ and about which encapsulated wiring 48′ is positioned. The magnets 42 and 42′ are placed within the bore of the coil 44′ so that the magnets 42 and 42′ repel each other. In other words, the magnets 42 and 42′ are in repulsion mode within the larger coil 44′ so that the driver assembly 24′″ has greater low frequency capability.

While the best mode for carrying out the invention has been described in detail, those familiar with the art to which this invention relates will recognize various alternative designs and embodiments for practicing the invention as defined by the following claims.

What is claimed is:

1. An integrated panel loudspeaker system adapted to be mounted in a vehicle, the system comprising:
a panel having a predetermined shape and at least one aperture formed therein;
an acoustical wave-producing, contour diaphragm for the panel wherein the diaphragm is secured to the panel so that the diaphragm is critically damped; and
at least one electromagnetic drive assembly having an electrical input and being secured to the panel in alignment with the at least one aperture wherein time and phase coherent, non-dispersive longitudinal waves are produced in the diaphragm by the at least one drive assembly so that the diaphragm radiates time coherent transverse waves within the vehicle with substantially the same wave form as that of the electrical input.

2. The system as claimed in claim 1 wherein the panel is formed of batting compressed and molded in the predetermined shape and having a plastic memory of the predetermined shape.

3. The system as claimed in claim 1 further comprising an adhesive for securing the diaphragm to the panel.

4. The system as claimed in claim 3 wherein the adhesive is a resilient adhesive for resiliently securing the diaphragm to the panel.

5. The system as claimed in claim 1 further comprising a plurality of spaced electromagnetic drive assemblies each having its own input wherein the panel has a plurality of apertures formed therein and wherein the drive assemblies are secured to the panel in alignment with their respective apertures so that time and phase coherent, non-dispersive longitudinal waves are produced in the diaphragm by the drive assemblies, and so that the diaphragm radiates time coherent transverse waves within the vehicle with substantially the same wave forms as that of the electrical inputs.

6. The system as claimed in claim 5 wherein each of the drive assemblies includes a coil and a magnet which moves relative to the coil in response to its electrical input.

7. The system as claimed in claim 6 wherein the diaphragm is fixedly secured to each of the magnets to move therewith.

8. The system as claimed in claim 7 wherein each of the magnets is a high-energy permanent magnet.

9. The system as claimed in claim 8 wherein each of the high-energy permanent magnets is a rare-earth magnet.

10. The system as claimed in claim 6 wherein at least one of the drive assemblies includes a pair of spaced apart magnets.

11. The system as claimed in claim 6 wherein the diaphragm is fixedly secured to each of the coils to move therewith.

12. The system as claimed in claim 1 wherein the longitudinal waves travel in the diaphragm at a velocity at least as great as the velocity of sound in the air in the vehicle.

13. The system as claimed in claim 12 wherein the diaphragm is formed from a non-ferrous metal.

14. The system as claimed in claim 13 wherein the non-ferrous metal is aluminum.

15. The system as claimed in claim 1 wherein the panel is adapted to be mounted adjacent a roof of the vehicle so as to underlie the roof and shield the roof from view.

16. The system as claimed in claim 1 wherein the panel is adapted to be mounted in a door of the vehicle.

17. An integrated panel loudspeaker system adapted to be mounted adjacent a roof of a vehicle so as to underlie the roof and shield the roof from view, the system comprising:
a panel having a predetermined shape and a plurality of apertures formed therein wherein the panel is formed of batting compressed and molded in the predetermined shape and having an elastic memory of the predetermined shape;
an acoustical wave-producing, contour diaphragm for the panel wherein the diaphragm is secured to the panel so that the panel critically damps the diaphragm; and
a plurality of spaced electromagnetic drive assemblies each having its own electrical input and being secured to the panel in alignment with their respective apertures wherein time and phase coherent, non-dispersive longitudinal waves are produced in the diaphragm by the drive assemblies so that the diaphragm radiates time coherent transverse waves within the vehicle with substantially the same wave forms as that of the electrical inputs.

18. An integrated panel loudspeaker system adapted to be mounted adjacent a roof of a vehicle so as to underlie the roof and shield the roof from view, the system comprising:
a panel having a predetermined shape and a plurality of apertures formed therein;
an acoustical wave-producing, contour diaphragm for the panel wherein the diaphragm is secured to the panel so that the diaphragm is critically damped; and
a plurality of spaced electromagnetic drive assemblies each having its own electrical input and being secured to the panel in alignment with their respective apertures wherein time and phase coherent, non-dispersive longitudinal waves are produced in the diaphragm by the drive assemblies at a velocity at least as great as the velocity of sound is the air in the vehicle so that the diaphragm radiates time coherent transverse waves within the vehicle with substantially the same wave forms as that of the electrical inputs.

19. The system as claimed in claim 18 further comprising an adhesive for securing the diaphragm to the panel.

20. The system as claimed in claim 19 wherein the adhesive is a resilient adhesive for resiliently securing the diaphragm to the panel.
